(19) United States
(12) Patent Application Publication
(10) Pub. No.: US 2025/0053793 A1
(43) Pub. Date: Feb. 13, 2025

(54) SYSTEMS AND METHODS FOR ORCHESTRATING LLM-AUGMENTED AUTONOMOUS AGENTS

(71) Applicant: Salesforce, Inc., San Francisco, CA (US)

(72) Inventors: Zhiwei Liu, Palo Alto, CA (US); Weiran Yao, San Francisco, CA (US); Jianguo Zhang, San Jose, CA (US); Le Xue, Mountain View, CA (US); Shelby Heinecke, San Francisco, CA (US); Rithesh Murthy, San Francisco, CA (US); Yihao Feng, Austin, TX (US); Zeyuan Chen, Mountain View, CA (US); Juan Carlos Niebles Duque, Mountain View, CA (US); Devansh Arpit, San Francisco, CA (US); Ran Xu, Pacifica, CA (US); Lik Mui, San Francisco, CA (US); Huan Wang, Palo Alto, CA (US); Caiming Xiong, Menlo Park, CA (US); Silvio Savarese, Palo Alto, CA (US)

(21) Appl. No.: 18/494,393

(22) Filed: Oct. 25, 2023

Related U.S. Application Data
(60) Provisional application No. 63/518,843, filed on Aug. 10, 2023.

(51) Int. Cl. G06N 3/047; G06N 3/092

(52) U.S. Cl. CPC G06N 3/047; G06N 3/092

(57) ABSTRACT

Embodiments described herein provide a method of predicting an action by a plurality of language model augmented agents (LAAs). In at least one embodiment, a controller receives a task instruction to be performed using an environment. The controller receives an observation of a first state from the environment. The controller selects a LAA from the plurality of LAAs based on the task instruction and the observation. The controller obtains an output from the selected LAA generated using an input combining the task instruction, the observation, and an LAA-specific prompt template. The controller determines the action based on the output. The controller causes the action to be performed on the environment thereby causing the first state of the environment to change to a second state.

### CROSS REFERENCE(S)

The instant application is a nonprovisional of and claim priority under 35 U.S.C. 119 to U.S. provisional application No. 63/518,843, filed Aug. 10, 2023, which is hereby expressly incorporated by reference herein in its entirety.

The instant application is related to co-pending and commonly-owned U.S. nonprovisional application no. 70689.284US01, filed TBD, which is hereby expressly incorporated herein by reference in its entirety.

The instant application is related to co-pending and commonly-owned U.S. nonprovisional application no. 70689.284US02, filed TBD, which is hereby expressly incorporated herein by reference in its entirety.

### TECHNICAL FIELD

The embodiments relate generally to machine learning systems for autonomous agents, and more specifically to systems and methods for orchestrating large language model (LLM) augmented autonomous agents.

### BACKGROUND

Machine learning systems have been widely used in autonomous agents. For example, an autonomous agent may be queried as to a next action to perform in pursuit of a specific goal, such as to book travel plans, to trouble shoot Information Technology (IT) issues, and/or the like. Large language models (LLMs) may be utilized to provide an agent response and/or reasoning, referred to as LLM-augmented Autonomous Agents (LAAs). Existing LAAs are often limited by the maximum size of context input (e.g., supporting documents based on which the LLM may seek for information relevant to the query, such as IT supporting documents on how to resolve login issues, how to trouble shoot failure to connect to Internet, and/or the like) of an LLM.

### BRIEF DESCRIPTION OF THE DRAWINGS

FIG. 1 is a simplified diagram illustrating an LLM-augmented autonomous agent framework according to some embodiments.

FIG. 2 is a simplified diagram illustrating an autonomous agent orchestration framework according to some embodiments.

FIG. 3A is a simplified diagram illustrating a computing device implementing the autonomous agent orchestration framework described in FIGS. 1-2, according to some embodiments.

FIG. 3B is a simplified diagram illustrating a neural network structure, according to some embodiments.

FIG. 4 is a simplified block diagram of a networked system suitable for implementing the autonomous agent orchestration framework described in FIGS. 1-3B and other embodiments described herein.

FIG. 5 is an example logic flow diagram illustrating a method of autonomous agent orchestration based on the framework shown in FIGS. 1-4, according to some embodiments.

FIGS. 6-10B provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “language model” (LM) describes a parameterized model, for example a neural-network based model, that receives inputs and generates corresponding outputs. In some embodiments, the inputs are text prompts, and the outputs are text outputs, which may include natural language text, symbols, code, etc.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

An LLM-augmented Autonomous Agent (LAA) may be used to perform actions in an environment. For example, an agent presented with a multi-step question answering task of “answer the question: The 2016 Washington State Cougars were led by the coach who previously helmed which other team?” may perform a series of steps interacting with an environment (e.g., Wikipedia) with the goal of answering the question. However, existing LAAs do not always provide accurate next-action indications and therefore a target task may not be completed.

Embodiments provide systems and methods for building an architecture of selected LAAs that jointly perform a target task. For example, each LAA in the architecture may be optimized for a particular function, either through fine-tuning the underlying LLM itself or optimizing a particular prompt for the underlying LLM. When a controller is given a task prompt describing a target task, the controller determines which LAA from a pool of available LAAs is best suited for predicting a next action at every iteration. The controller may then transmit a message to the selected LAA, which is appended with the selected LAA's particular prompt, and receives back the output from the selected LLM. After performing the action indicated by the selected LAA, an observation of the environment provides feedback which is used in selecting the next LAA and constructing a message to send to the LAA, continuing the iterative process. This process allows for higher accuracy results as each LAA is optimized for particular functions.

For example, each selected LAA may only focus on generating one type of actions. For example, one environment may be an interface for navigating websites on the internet, such as a web browser, and/or the like. A task which may be performed on this environment may be answering a multi-step question such as “It Takes a Family is a response to this 1996 book that was published by who”. Answering this question may require searching on the Internet based on a search query of the title of the book, then accessing returned links of results to search for the publisher and then generating an answer to the query based on the searched information. To accomplish this task on the environment of a web browser, some steps may require the LAA to click links or buttons on websites. Other steps may require entering text into a search field. In some embodiments, an LAA is selected to perform a specific step based on its specialization. For example, a “click” LAA may be specialized in selecting which link to click on a website, and a “search” LAA may be specialized in generating search terms for being entered into a search field. A controller may select at each step which of the LAAs in a LAA pool will be used to generate the next action. In this way, a more complex task is subdivided into more feasible tasks.

Embodiments described herein provide a number of benefits. For example, as multiple LLMs may be selected to execute actions in multiple steps in order to jointly complete a task, the multiple LLMs are no longer limited to the context size of a single LLM as context information may be distributed into the generation tasks of multiple steps. With enhanced capacity of utilizing context information in performing a task, the actions to achieve the task goal may be more accurate in achieving the desired result than a single-LLM LAA. Therefore, neural network technology in language model autonomous agents is improved.

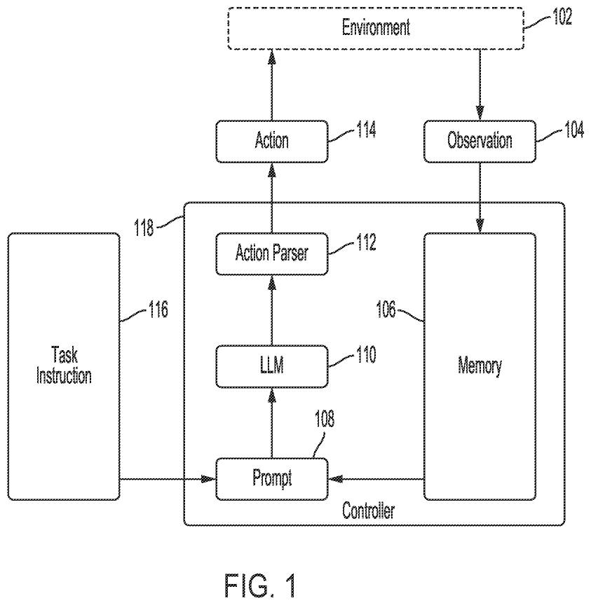

FIG. 1 is a simplified diagram illustrating an LLM-augmented autonomous agent framework 100 according to some embodiments. Framework 100 includes a controller 118 which receives a task instruction 116. Controller 118 selects actions 114 to perform on environment 102 in an attempt to complete the task indicated by task instruction 116. For example, environment 102 may be a web browser interface which is able to navigate websites, and interact with them by selecting buttons/links and filling in text fields. A task instruction 116 may be “buy an electric guitar”. Based on this task instruction 116, controller 118 may select actions 114 such as “[URL]Amazon.com”, “[Search] Electric guitar”, “[Click]item(1)”, “[Click] Checkout”, etc. The format of the actions generated by controller 118 may be in a format which is acceptable to a particular environment 102. In the list of actions above, for example, the type of action is in brackets, and the specific button to click or text to enter follows the bracketed indicator. Other formats may be used depending on environment 102. For example, environment 102 may further comprise an application programming interface (API) which may control a variety of software programs and/or physical hardware components, each with a particular set of available actions. In some embodiments, controller 118 is configured for a particular environment. In some embodiments, controller 118 is utilized on a new environment 102 for which it must determine available actions, for example via trial and error.

In some embodiments, controller 118 may be implemented by a large language model (LLM) 110 which generates an action or actions based on prompt 108. The output of LLM 110 may be used directly on environment 102, or an action parser 112 may be used to ensure that the output of LLM 110 is in the correct format to be received by environment 102. In some embodiments, multiple action parsers 112 may be utilized, each for use with a different environment 102. For example, a controller 118 may be configured to act on both an e-commerce environment 102, and an information searching environment 102. Based on the specific task instruction 116, controller 118 may select an appropriate action parser 112 for the environment 102 that is best suited for completing the task instruction 116.

After each action 114 or multiple actions 114, environment 102 may provide updated information about the state of environment 102 via observation 104, communicated to controller 118. The state may include, for example, available actions (e.g., buttons/links and text entry fields). For some environments, actions may include physical processes such as controlling a robotic arm, adjusting physical parameters that may be defined over observed or predetermined ranges. Observation 104 of a state of environment 102 may also include other information besides available actions such as error messages, text output, images displayed by environment 102, etc. Observation 104 may be stored in a memory 106. Memory 106 may be used to store which actions were performed and the resulting environments states after each action. The prior actions and states of environment 102 as stored in memory 106 may be used together with task instruction 116 to generate an updated prompt 108.

For example, task instruction may be “buy an electric guitar”. The first prompt 108 to LLM 110 may be generated solely based on the task instruction 116 and a predetermined prompt template. The prompt template may describe the purpose of LLM 110 in determining actions to be performed on an environment 102, and may describe the expected types of actions that may be performed on the environment 102. The specific task instruction 116 may be appended or otherwise included in the predefined template prompt to provide prompt 108. The initial action generated by LLM 110, either directly or after being parsed by action parser 112, may be “[URL]Amazon.com”. The resulting observation 104 may be a description of the Amazon.com website including which links are available and which text fields are available, including the search bar. This observation 104 may be stored in memory 106. Prompt 108 may be updated to include the first action taken and the resulting observation 104 in addition to the prompt template and task instruction 116. Based on this updated prompt 108, LLM 110 may generate a next action, for example “[Search] Electric guitar”. This process may continue to iterate with additional actions 114 and observations 104 until the task is complete. Controller 118 may determine the task is complete. For example, after each observation 104, a neural network based model (e.g., LLM 110) may be given a prompt asking whether the observation 104 represents the completion of the task described in task instruction 116. In some embodiments, LLM 110 indicates a generated action is the final action required, rather than determining based on a final observation 104.

In some embodiments, controller 118 may perform multiple attempts at completing the same task identified by task instruction 116, each attempt comprising a series of actions 114. For example, controller 118 may perform a predetermined number of attempts for completing task instruction 116. In some embodiments, controller 118 stops the attempts after a successful attempt. In some embodiments, controller 118 performs a predetermined number of attempts, continuing even after a successful attempt. This may be done to look for more efficient (e.g., fewer actions) or otherwise more desirable set of actions 114 (e.g., requiring fewer memory resources or some other constraint). In some embodiments, environment 102 may be a simulated environment, so that unsuccessful attempts do not result in incorrect actions 114 being performed on a real environment 102. For example, in an e-commerce environment, it may be desirable to first validate a set of actions 114 on a simulated environment so that incorrect items are not purchased while performing the attempts. In some embodiments, after a successful attempt on a simulated environment, controller 118 performs the validated actions 114 on a real environment 102 (e.g., a live website).

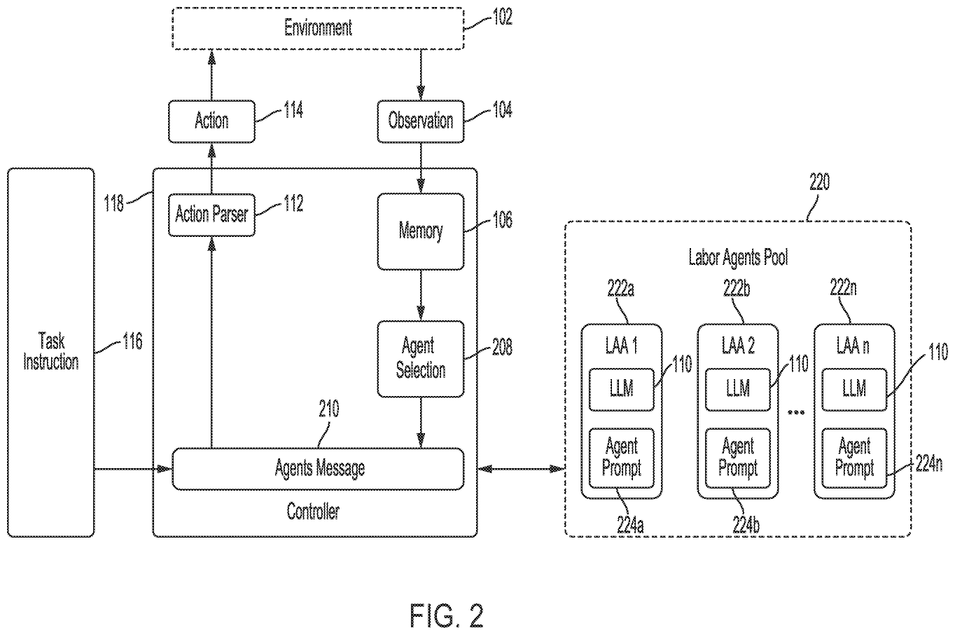

FIG. 2 is a simplified diagram illustrating the custom Al agent framework 200 according to some embodiments. The general function of controller 118 in FIG. 2 is similar to FIG. 1. Controller 118 receives a task instruction 116, generates actions 114 for an environment 102, receives observations 104, and stores them in a memory 116, similar to FIG. 1. As illustrated in FIG. 2, however, some embodiments include a labor agents pool 220. Labor agents pool 220 may be on the same device (e.g., processor) as controller 118, or separate (e.g., in a remote server). Labor agents pool 220 includes LLM-Augmented autonomous agents (LAAs) 222a-222n. Each LAA 222 may include an LLM 110 and an LAA-specific agent prompt 224a-224n. LAAs 222a-222n may each be specialized in some way. For example, LAA 222a may be a “click” agent, which is specialized in determining which button to click on a web interface environment 102. LAA 222b may be a “search” agent which is specialized in determining what search terms to use in a search field. By using specialized LAAs, complex tasks may be divided into more feasible tasks. In some embodiments, LAAs 222a-222n are specialized by having distinct LLMs 110 which have fine-tuned parameters for their specific function. In some embodiments, each LAA 222a-222n uses the same LLM 110 parameters. When using the same parameters, LAAs 222a-222n may use the same LLM 110, which is shared by the LAAs which access the shared LLM 110 at different times.

In some embodiments, LAAs 222a-222n are specialized by the use of different prompt templates. For example, a “click” agent may have a predefined prompt template which describes for the LLM 110 an optimized way of selecting a button to click. In some embodiments, the prompt template is optimized through a prompt tuning process which iteratively updates the prompt based on feedback. Agent prompts 224a-224n may include LAA-specific prompt templates appended with information from agents message 210. LLMs have limited “context” size, meaning the input prompt may only be of a certain length. By having specialized prompt templates only for specific actions, the context size of the LLM is utilized more efficiently. For example, the “click” agent does not necessarily need information about how to generate search terms, so that information does not need to be included in the “click” prompt template, allowing for more “click” related information to be included, or to otherwise reduce the size of the prompt.

In some embodiments, rather than directly inputting a prompt to an LLM 110 to generate an action 114, controller 118 first selects an agent via agent selection 208. The selected agent (i.e., one of LAA 222a-222n) is transmitted an agents message 210. In some embodiments, agents message 210 includes task instruction 116, an indication of which LAA is selected, an indication of past actions 114 from the current and/or previous attempts, and/or observations 104 from the current attempt and/or previous attempts. Controller 118 may communicate agents message 210 directly to the selected LAA. In some embodiments, controller 118 indicates to labor agents pool 220 which LAA is selected, and a second controller or some other mechanism associated with labor agents pool 220 directs agents message 210 to the appropriate LAA 222. An agent prompt 224 is generated based on agents message 210. For example, information from agents message 210 may be appended to an LAA-specific prompt template. Agent prompt 224 (e.g., 224a-224n) is input to the corresponding LLM 110. LLM 110 generates a response based on the agent prompt 224. The generated LLM 110 response is communicated back to controller 118. Similar to FIG. 1, an action parser may parse the output of the LLM 110 and cause action 114 to be executed on environment 102. Similar to FIG. 1, the process of generating actions, executing them on environment 102, and receiving observations 104 may be iteratively repeated.

In some embodiments, agent selection 208 selects an LAA based on the most recent observation 104. In some embodiments, the selection of an LAA agent may be performed according to a predefined heuristic. In some embodiments, agent selection 208 may select an agent based on which actions are available for the current state of environment 102. For example, the most recent observation 104 may indicate that environment 102 after the most recent action 114 is in a state that has the option of clicking one of four different buttons, with no other actions available. Agent selection 208 may select a “click” agent based on the available actions only including “click” type actions. In some embodiments, agent selection 208 may select an LAA based on which actions have been performed in the current attempt and/or prior attempts.

In some embodiments, agent selection 208 uses a neural network based model (e.g., an LLM or other language model). A model-based agent selection 208 may use observations 104, actions 114, task instruction 116, and/or additional data as inputs, and based on those inputs generate a selected LAA for generating the next action. If agent selection 208 is implemented as an LLM, a prompt template may be used which describes the available LAAs, and/or criteria by which different LAAs should be selected. Information such as actions 114, observations 104, and/or task instruction 116 may be appended to the prompt template and input to the agent selection 208 LLM, which then generates a selected LAA. A model-based agent selection 208 may be trained by updating parameters of the model to minimize a loss function, where the loss function is based on actions 114 and/or observations 104 from an attempt compared to ground-truth actions 114 and/or observations 104. In some embodiments, reinforcement learning may be performed with a reward determined by a reward model, by human feedback, by self-validation of LLM 110, or some other reward method.

In some embodiments, one or more of LAAs 222a-222n may perform some function other than generating a next action. For example, an LAA may be a “reflective” LAA, which generates reflections indicating information relating to the performance of previously taken actions 114 in light of observations 104. For example, for a task instruction 116 of “Answer the question: It Takes a Family is a response to this 1996 book that was published by who”, a first attempt may include an action of “Search [‘It Takes a Family’]”. Observations 104 from this action and subsequent actions may not result in a correct answer to the question. For a next attempt, agent selection 208 may select a “reflective” LAA, and communicate an agents message 210 to the reflective LAA with the task instruction 116, the set of actions 114 from the failed attempt and the corresponding observations 104. The reflective LAA may respond with a reflection such as “I should have included in the search terms that ‘It Takes a Family’ is a book, to filter out results related to other things besides books.” This reflective text may be included in an agents message 210 to supplement agent prompts 224 in a next attempt in order to assist the other LAAs in generating correct actions. In some embodiments, one or more of LAAs 222a-222n may be a “think-plan” agent which is given a prompt to generate a plan for accomplishing task instruction 116. A think-plan agent may be used similarly to a reflective LAA, but may be used before an attempt without reflecting on previous attempts, and/or may be used between each action generated by other LAAs. For example, a think-plan agent may generate a plan such as “I need to search for the title of the book, ‘It Takes a Family’ and who published it”. This plan may be included in an agents message 210 to supplement agent prompts 224 in the generation of a next action.

### Computer and Network Environment

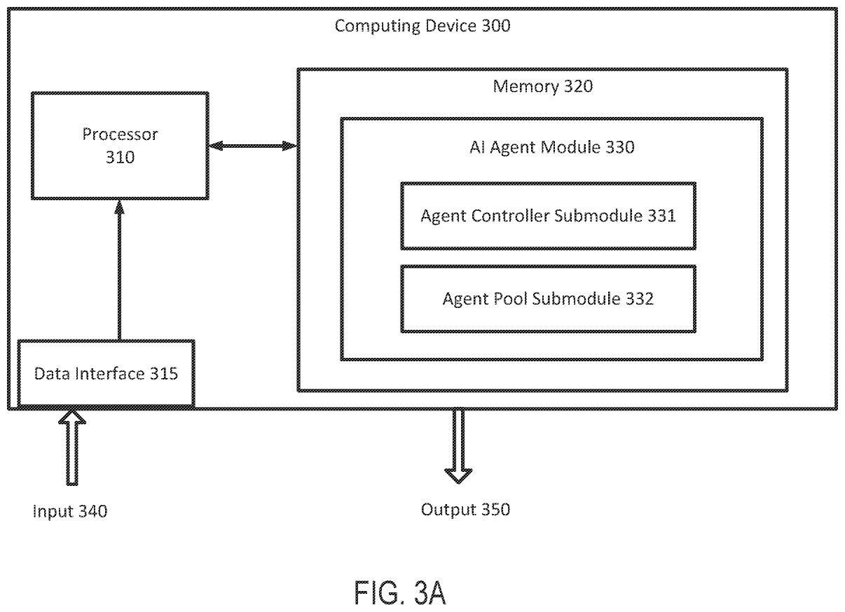

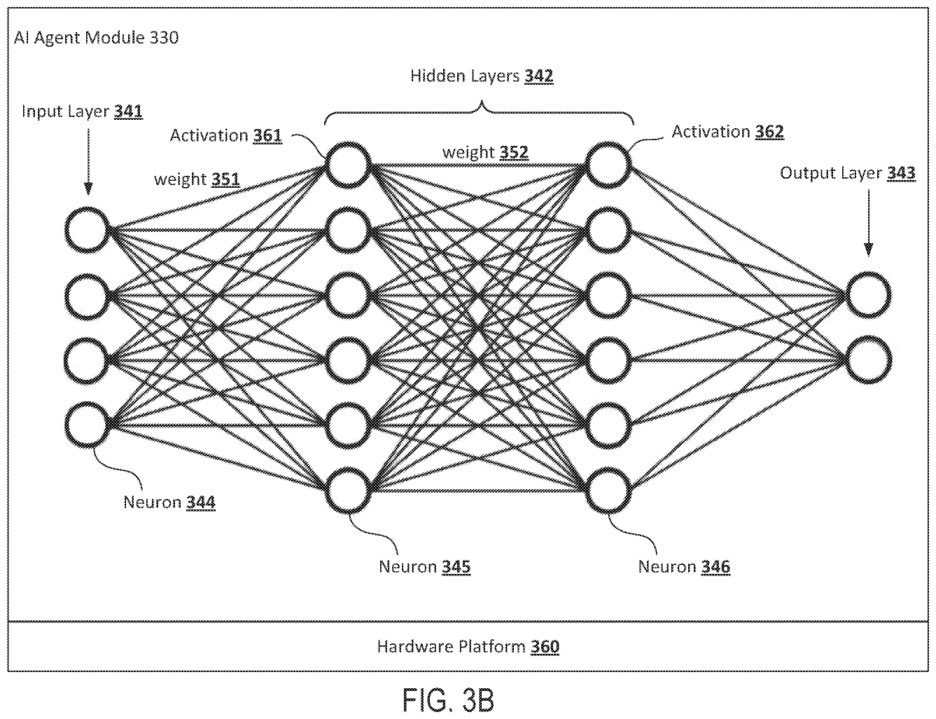

FIG. 3A is a simplified diagram illustrating a computing device implementing the autonomous agent orchestration framework described in FIGS. 1-2, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for Al agent module 330 that may be used to implement and/or emulate the systems and models, and/or to implement any of the methods described further herein. Al agent module 330 may receive input 340 such as an input training data (e.g., task instructions and desired results) via the data interface 315 and generate an output 350 which may be a sequence of actions.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as a task instruction from a user via the user interface.

In some embodiments, the Al agent module 330 is configured to determine actions to be performed on an environment. Al agent module 330 may further include agent controller submodule 331 (e.g., similar to controller 218 in FIG. 2). Agent controller submodule 331 may be configured to select and prompt agents based on a task instruction, and cause actions to be performed on an environment as described in embodiments herein. Al agent module 330 may further include agent pool submodule 332 (e.g., similar to labor agents pool 220 in FIG. 2). Agent pool submodule 332 may be configured to prompt a selected agent as indicated by the controller as described in embodiments herein.

In one embodiment, agent controller submodule 331 and agent pool submodule 332 may be located on a server implemented by the computing device 300. In another embodiment, a pool of LAAs may be hosted on one or more external servers, and agent pool submodule 332 may serve as a gateway for agent controller submodule 331 to access the external LAAs.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the Al agent module 330 described in FIG. 3A, according to some embodiments. In some embodiments, the Al agent module 330 and/or one or more of its submodules 331-332 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as task instructions. The number of nodes (neurons) in the input layer 341 may be determined by the dimensionality of the input data (e.g., the length of a vector of a task instruction. Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the Al agent module 330 receives an input 340 of a task instruction and transforms the input into an output 350 of an agent message. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the Al agent module 330 and/or one or more of its submodules 331-332 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may bean LLM, and/or the like.

In one embodiment, the Al agent module 330 and its submodules 331-332 may be implemented by hardware, software and/or a combination thereof. For example, the Al agent module 330 and its submodules 331-332 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated Al accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In one embodiment, the neural network based Al agent module 330 and one or more of its submodules 331-332 may be trained by iteratively updating the underlying parameters (e.g., weights 351, 352, etc., bias parameters and/or coefficients in the activation functions 361, 362 associated with neurons) of the neural network based on a loss objective. For example, during forward propagation, the training data such as task target prompts and associated actions are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding ground truth sequence of actions from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

Parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as new tasks and/or new environments.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in Al agents.

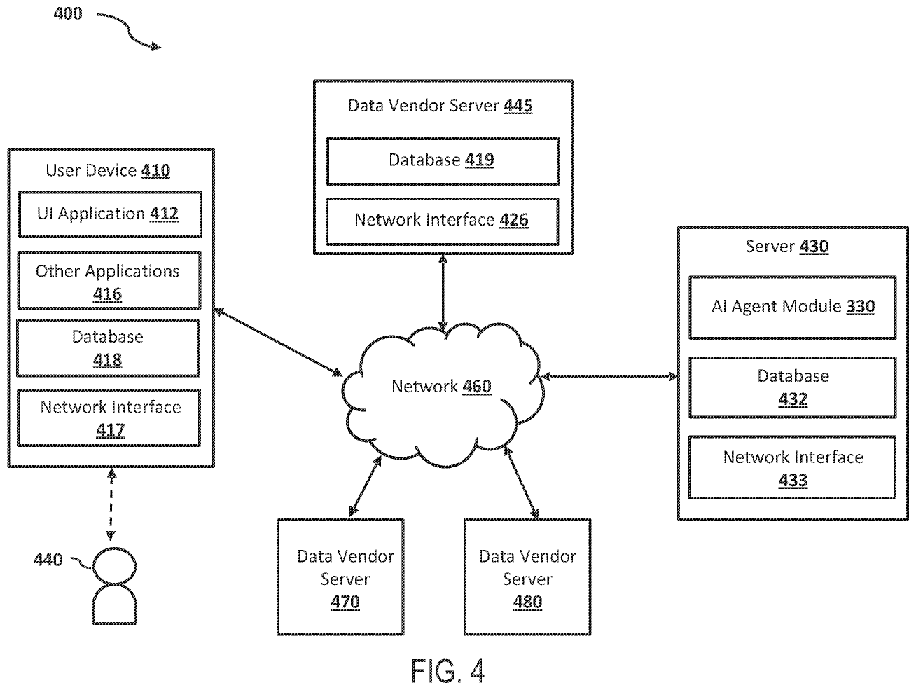

FIG. 4 is a simplified block diagram of a networked system suitable for implementing the autonomous agent orchestration framework described in FIGS. 1-3B and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

In one embodiment, one or more of data vendor servers 445, 470, 480 may host LAAs, that are accessible by server 430 via network 460. For example, each data vendor server 445, 470, 480 may host a LLM API for the specific LLM it hosts.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD®from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating a sequence of actions and/or the results of executing actions on an environment from the server 430 and display the message via the UI application 412. In other embodiments, user device 410 may include additional or different modules having specialized hardware and/or software as required.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view provided data.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including task prompts to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the Al agent module 330 and its submodules described in FIG. 3A. In some implementations, Al agent module 330 may receive data from database 419 at the data vendor server 445 via the network 460 to generate action sequences and/or results of executing actions on an environment. The generated actions may also be sent to the user device 410 for review by the user 440 via the network 460.

The database 432 may be stored in a transitory and/or non-transitory memory of the server 430. In one implementation, the database 432 may store data obtained from the data vendor server 445. In one implementation, the database 432 may store parameters of the Al agent module 330. In one implementation, the database 432 may store previously generated actions, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

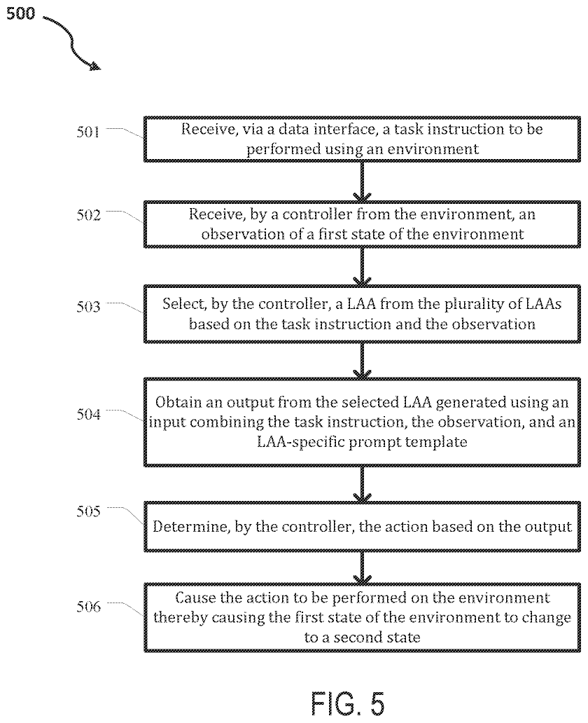

FIG. 5 is an example logic flow diagram 500 illustrating a method of autonomous agent orchestrations based on the framework shown in FIGS. 1-4, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the Al agent module 330 (e.g., FIGS. 3A and 4) that determines actions to be performed on an environment.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 501, a system (e.g., computing device 300, user device 410, or server 430) receives, via a data interface (e.g., data interface 315), a task instruction to be performed using an environment (e.g., environment 102).

At step 502, the system receives, by a controller from an environment, an observation of a first state of the environment. The observation may include, for example, results of previous actions (e.g., an indication of success or a response to a query), and/or available actions to perform (e.g., buttons that may be selected, text fields that may be populated, etc.). Observations may include other outputs of the environment, such as text and images displayed by the environment, sensor readings etc.

At step 503, the system selects, by the controller, a language model augmented agent (LAA) from a plurality of LAAs based on the task instruction and the observation. In some embodiments, selecting the LAA is based on an available action determined based on the observation. For example, if it is observed that a text search field is available, then a “text search” agent may be selected. In some embodiments, selecting the LAA is performed using a neural network based model. For example, a model may be trained to select an LAA based on previous actions and/or observations. In some embodiments, at least two LAAs of the plurality of LAAs use a single shared language model. The LAAs may be distinguished/specialized by different agent-specific prompts which are appended to the prompt which is provided as an input to the shared language model. In some embodiments, all of the LAAs may use the same shared language model. By sharing a single shared language model, only a single set of parameters may be stored in memory. In some embodiments, the plurality of LAAs are hosted on an external server separate from the controller. In some embodiments, the plurality of LAAs are hosted on a same server separate as the controller.

At step 504, the system obtains an output from the selected LAA generated using an input combining the task instruction, the observations, and an LAA-specific prompt template. In some embodiments, the output includes a recommended action. In some embodiments, the output includes a reflection on the performance of one or more past actions performed on the environment. For example, a reflective LAA may be given a prompt to reflect on previous actions or attempts, and recommend how the approach may be changed. Subsequent prompts to the LAAs may be updated on subsequent attempts based on the reflection in order to improve the performance.

At step 505, the system determines, by the controller, an action based on the output. In some embodiments, when the output includes a recommended action, determining the action is done by extracting the recommended action from the response. For example, the recommended action in the response may be in a different format than is used by the controller to cause the action to be performed, so the controller may extract the recommended action and put it into a specific format.

At step 506, the system causes the action to be performed on the environment thereby causing the first state of the environment to change to a second state. In some embodiments, the system determines a second action based on a determination that the action was not successful. For example, after a failed attempt, the system may start a second attempt, and the prompts used during the second attempt may indicate to the selected LAA what action was tried previously that failed.

The system may continue to iterate and select additional actions following the same process of receiving observations from the environment, selecting an LAA, inputting a prompt to the selected LAA, receiving an action recommendation from the LAA, and performing the action, etc. The system may determine (e.g., by the controller) whether the actions successfully completed the task instruction. The system may perform another attempt by restarting the environment and trying a new set of actions determined in the same way. Since the LAAs use LLMs for determining actions, a temperature setting of the LLMs may provide some randomness to the outputs, resulting in different actions being performed at each attempt. The controller may determine an attempt was successful or not successful by collecting feedback from the environment. In some embodiments, an LLM is given the task instruction, the actions, and/or the observations from the environment with a prompt asking the LLM to determine whether the task was successfully performed. In some embodiments, a human user indicates whether the task was successful.

### Example Results

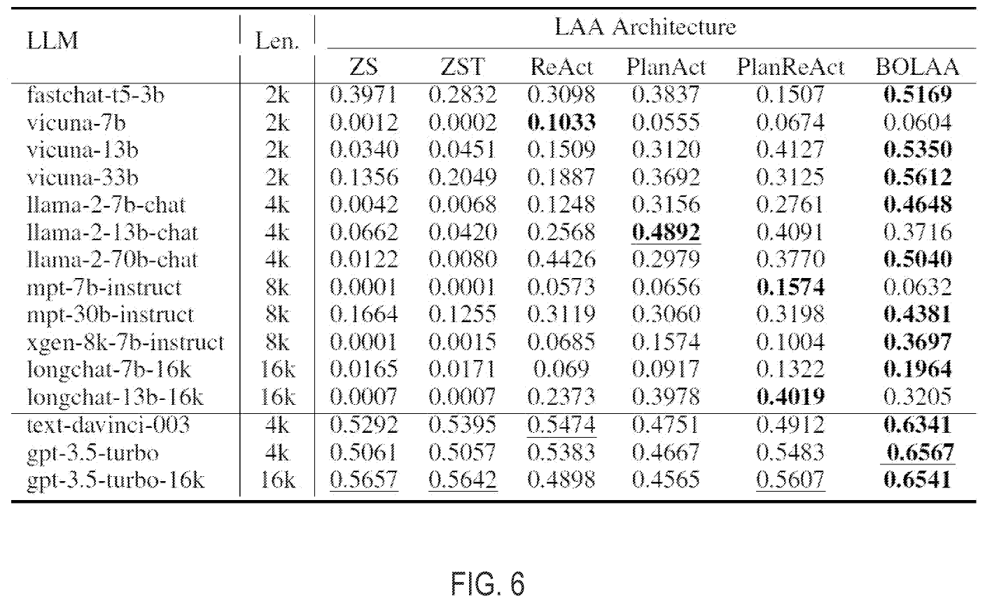

FIGS. 6-10B provide charts illustrating exemplary performance of different embodiments described herein. Evaluation benchmarks were created from two environments. First, WebShop as described in Yao et al., Webshop: Towards scalable real-world web interaction with grounded language agents, arXiv:2207.01206, 2022. Second, HotPotQA as described in Yanh et al., HotpotQA: A dataset for diverse, explainable multi-hop question answering, In Conference on Empirical Methods in Natural Language Processing (EMNLP), 2018. HotPotQA was used with Wikipedia API as described in Yao et al., ReAct: Synergizing reasoning and acting in language models, In International Conference on Learning Representations (ICLR), 2023. WebShop is a recently proposed online shopping website environment with 1.18M real-world products and human instructions. Each instruction is associated with one ground-truth product, and contains attribute requirements, e.g. I'm looking for a travel monopod camera tripod with quick release and easy to carry, and price lower than 130.00 dollars. This instruction includes 3 attribute requirements i.e. “quick release”, “camera tripod” and “easy carry” attributes. The complexity of an instruction was defined using the number of attribute requirements. Thus, this instruction example above is of complexity 3. Experiments equally sampled 150 instructions regarding each complexity level. Since there are fewer than 150 instructions for complexity larger than 6, only instructions from complexity in {1, 2, . . . , 6}were included, which sums up to 900 tasks for benchmark evaluation in the WebShop environment. In the WebShop environment, an agent operates either SEARCH [QUERY] or CLICK[ELEMENT]actions to interact the environment, for evaluating the interactive decision making ability of LAA. The observation from WebShop is simplified web browser, which includes the clickable buttons and associated page content. LAA interacts with the WebShop environment as a web navigation agent.

HotPotQA with Wikipedia API is another environment considered in the experiments whose results are illustrated in FIGS. 6-10B, which contains multi-hop questions answering tasks that requires reasoning over two or more Wikipedia passages. This simulation environment serves as a powerful tool for evaluating the multi-step planning and comprehension capabilities and information retrieval skills of Al models, ensuring they are proficient in sourcing reliable information from vast online resources. With its unique blend of real-world internet browsing scenarios and text analysis, HotpotQA is an invaluable asset for the advancement of augmented large language agent systems. In HotPotQA environment, an agent has three types of actions, i.e., SEARCH[ENTITY], LOOKUP[STRING] and FINISH[ANSWER] to interact with HotPotQA environment. HotPotQA environment aims at evaluate the knowledge reasoning ability of LAA. 100 questions from easy, medium and hard levels were randomly sampled, which constitutes the final 300 benchmark questions for evaluating LAAs.

For a metric for comparing the different models, the experiments mainly use the reward score in each environment to evaluate the performances of LAAs. In the WebShop environment, the reward is defined as the attribute overlapping ratio between the bought item and ground truth item. In HotPotQA environment, the reward is defined as the F1 score grading between agent answer and ground-truth answer. Additionally, a newly developed Recall performance for WebShop environment, which is defined as 1 if the ground truth item is retrieved and 0 if not during one task session. The Recall is reported as the average recall scores across all tasks in WebShop environment.

FIG. 6 provides a chart illustrating exemplary performance of at least one embodiment described herein. Specifically, FIG. 6 illustrates an Average reward in the WebShop environment. Len denotes the maximum context length. Bold results denote the best results in one row, i.e. best LAA architecture with respect to one LLM. Underlined results denote the best performance in one column, i.e. best LLM regarding one LAA architecture. Results are illustrated with respect to LLM models such as fastchat-3b, vicuna-3b/13b/33b (Zheng et al., 2023), Llama-2-7b/13b/70b6 (Touvron et al., 2023), MPT-7b/30b (Team, 2023), xgen-8k-7b, longchat-16k-7b/13b and OpenAI API LLMs, including text-davinci-003, gpt-3.5-turbo and gpt-3.5-turbo-16k. The column labeled custom Al agent represents the performance of an implementation of at least one of the embodiments described herein.

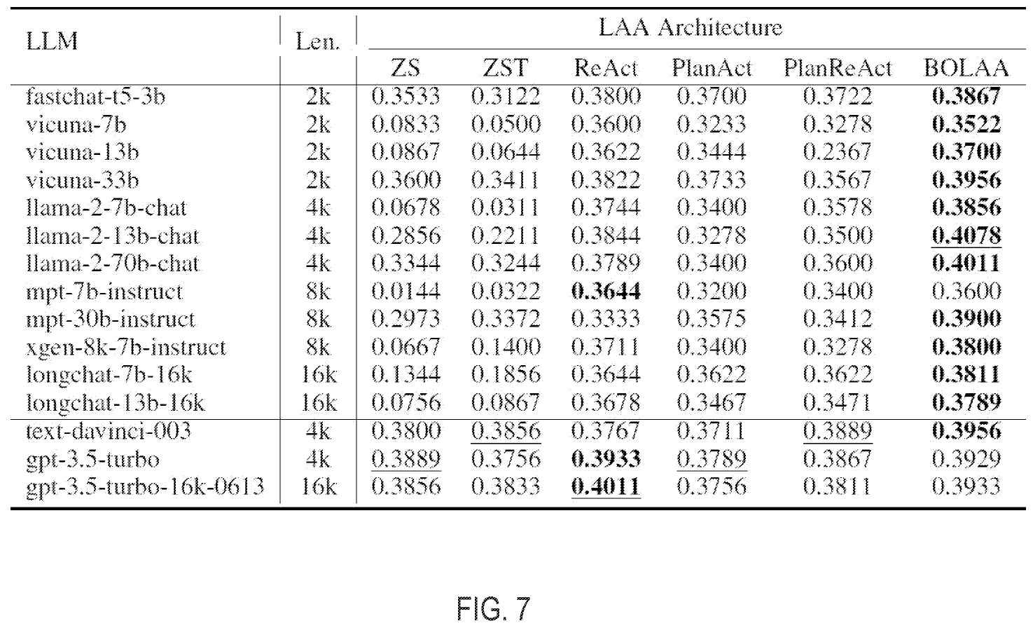

FIG. 7 provides a chart illustrating exemplary performance of at least one embodiment described herein. Specifically, FIG. 7 illustrates average recall in the WebShop environment. Len denotes the maximum context length. Bold results denote the best results in one row, i.e. best LAA architecture with respect to one LLM. Underlined results denote the best performance in one column, i.e. best LLM regarding one LAA architecture. Recall is mainly related to the search action. High recall performances indicate that the LAA is capable of generating a precise search query. High recalls usually lead to better rewards. But they are not tightly related. For example, Llama-2-70b has a recall performance of nearly 0.3344 on ZS LAA, which is comparable to the best LAA. However, the reward performance in Table 1 of ZS LAA Llama-2-70b is only 0.0122. The reason is that generating the search query requires a different LLM ability from generating the correct click action, where the latter is more challenging. Another observation is that custom Al agent generally performs the best on all LLMs, which indicates that separating the search agent from the click agent improves the accuracy of the search action, leading to a higher recall value.

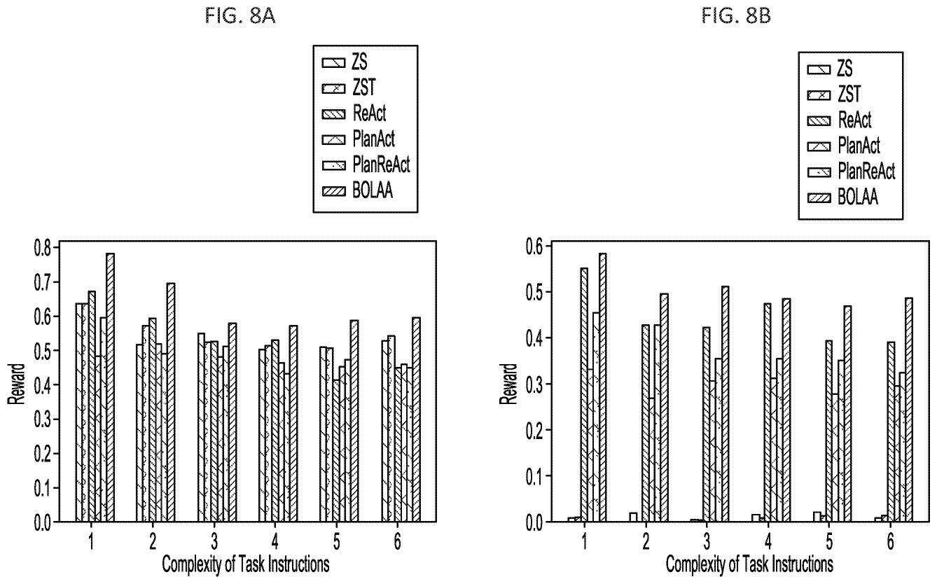

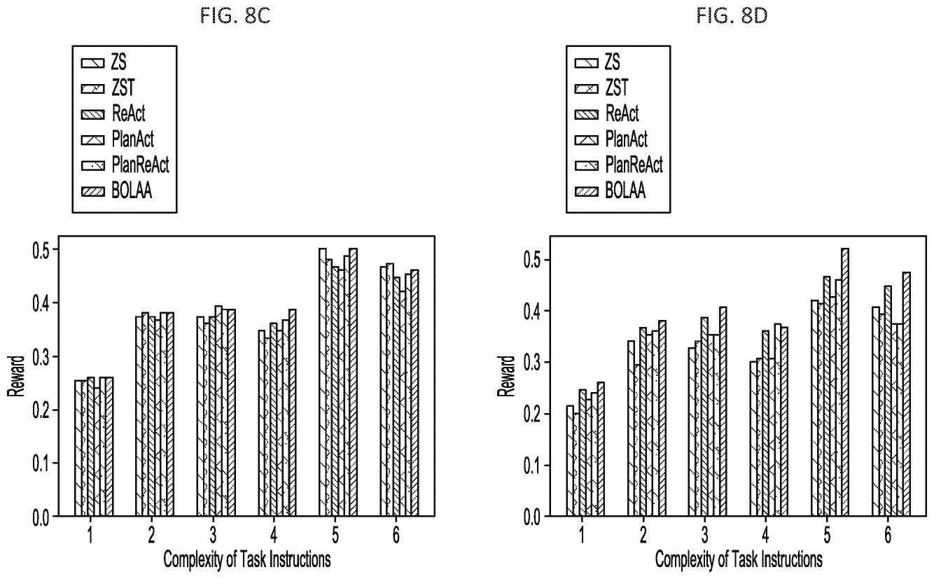

FIGS. 8A-8B provide charts illustrating exemplary performance of at least one embodiment described herein. Specifically, FIGS. 8A-8B illustrate the reward with respect to task complexity in WebShop. Each bar represents one LAA, with the last bar in each group representing custom Al agent. The custom Al agent model consistently performs better on all complexity levels. Also note the degraded performances when the task complexity is increased, which follows the intuition. Further increasing the complexity of tasks greater than 4 did not further degrade the performances. One explanation is that the recall performance increases when the task is of higher complexity, which is demonstrated in FIGS. 8C-8D. This may be due to the fact that high-complexity task instruction provides more additional context information for the LAA. As such, the search action can be more specific and accurate under high complexity levels.

FIGS. 8C-8D provide charts illustrating exemplary performance of at least one embodiment described herein. Specifically, FIGS. 8C-8D illustrate the recall with respect to task complexity in WebShop. Each bar represents one LAA, with the last bar representing custom Al agent.

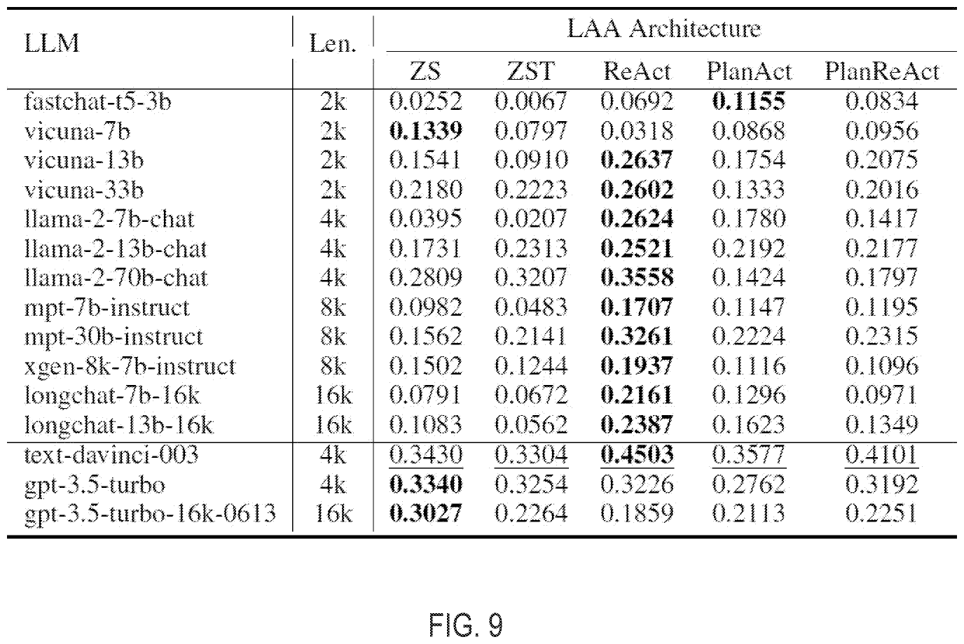

FIG. 9 provides a chart illustrating exemplary performance of at least one embodiment described herein. Specifically, FIG. 9 illustrates average reward in the HotPotQA environment. Len denotes the maximum context length. Bold results denote the best results in one row, i.e., best LAA architecture with respect to one LLM. Underline results denote the best performance in one column, i.e. best LLM regarding one LAA architecture. HotPotQA environment is benchmarked to evaluate the multi-step reasoning ability of LAAs. In general, ReAct agent architecture achieves the best performances, which can be interpreted in twofold. Firstly, fewshot prompt is necessary to enable the action generation and reasoning ability for LAA, especially when experimenting with those small-size language models. Secondly, comparing ReAct, PlanAct, and PlanReAct, one may conclude that planning flow of LAA hinders performance the in knowledge reasoning environment and tasks. The reason is that knowledge reasoning tasks require contextualized information to conduct reasoning, whereas planning flow is executed ahead of interactions. Thus, those generated plans tend to lead to more hallucination of LAA. Thirdly, regarding this knowledge reasoning task, model size is much more important than the context length. Large-sized model has better abilities in reasoning, thus performing better. Additionally, the superior reasoning ability of OpenAI gpt-3.5 models is again verified. Also note the best performance of Llama-2-70b on all open-source LLMs, which suggests that potential future fine-tuning can be applied on Llama-2 models.

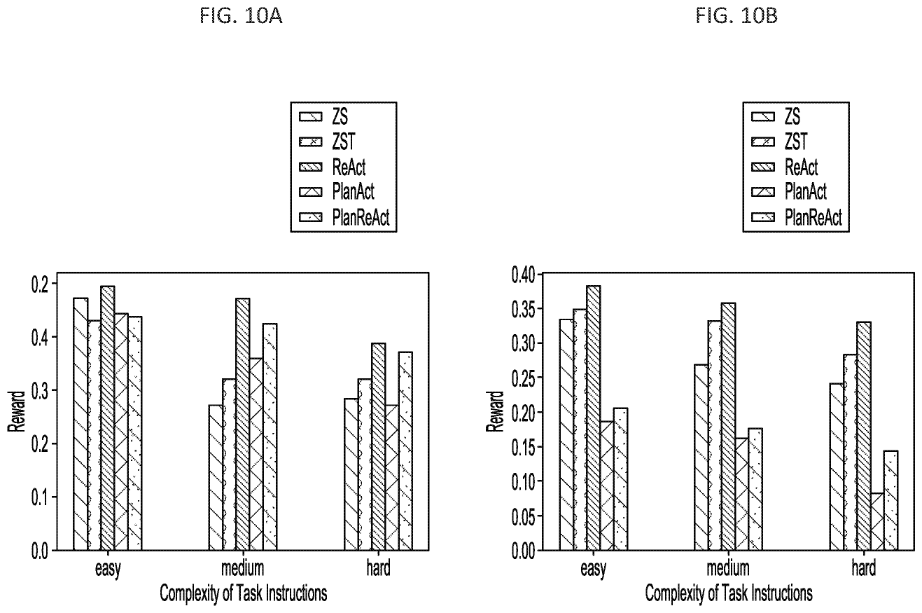

FIGS. 10A-10B provide charts illustrating exemplary performance of at least one embodiment described herein. Specifically, FIGS. 10A-10B illustrate the reward with respect to complexity level in HotPotQA. Each bar represents one LAA. Since there are easy, medium, and high level tasks, the performance of Llama-2-70b was compared regarding different levels of complexity. Note the degrading performance if increasing the complexity of tasks. In HotPotQA tasks, the hardness is defined as the question answer hops. Therefore, hard question requires more context understanding and reasoning ability of LAA. Though OpenAI text-davinci-003 model consistently outperforms Llama-2-70b on all levels of complexity, their difference is of smaller margin in hard questions. Since hard questions requires more reasoning efforts, one may conclude that Llama-2-70b posses comparable reasoning ability with text-davinci-003.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of predicting an action by a plurality of language model augmented agents (LAAs), the method comprising:
receiving, via a data interface, a task instruction to be performed using an environment;
receiving, by a controller from the environment, an observation of a first state of the environment;
selecting, by the controller, a LAA from the plurality of LAAs based on the task instruction and the observation;
obtaining an output from the selected LAA generated using an input combining the task instruction, the observation, and an LAA-specific prompt template;
determining, by the controller, the action based on the output; and
causing the action to be performed on the environment thereby causing the first state of the environment to change to a second state.

2. The method of claim 1, wherein the selecting the LAA from the plurality of LAAs comprises selecting the LAA based on an available action presented by the environment determined by the controller based on the observation of the first state.

3. The method of claim 1, wherein the selecting the LAA from the plurality of LAAs is performed by a neural network based model predicting which one of the plurality of LAAs is to be employed based on an input of the task instruction and the observation of the first state.

4. The method of claim 1, wherein the output from the selected LAA comprises a recommended action.

5. The method of claim 1, wherein the output from the selected LAA comprises information relating to the performance of one or more past actions performed on the environment.

6. The method of claim 1, wherein each LAA of the plurality of LAAs is implemented on a neural network based language model.

7. The method of claim 1, wherein the plurality of LAAs are hosted on one or more external servers.

8. The method of claim 1, wherein the plurality of LAAs are hosted on a same server as the controller.

9. The method of claim 1, further comprising:
collecting a feedback from the environment after the action is performed on the environment;
determining, by the controller, that the feedback indicates the action was unsuccessful to achieve a desired goal corresponding to the task instruction; and
determining, by the controller together with one or more of the plurality of LAAs, a subsequent action in response to the determination.

10. A system for predicting an action by a plurality of language model augmented agents (LAAs), the system comprising:
a memory that stores the plurality of LAAs and a plurality of processor executable instructions;
a communication interface that receives a task instruction to be performed using an environment; and
one or more hardware processors that read and execute the plurality of processor-executable instructions from the memory to perform operations comprising:
receiving, by a controller from the environment, an observation of a first state of the environment;
selecting, by the controller, a LAA from the plurality of LAAs based on the task instruction and the observation;
obtaining an output from the selected LAA generated using an input combining the task instruction, the observation, and an LAA-specific prompt template;
determining, by the controller, the action based on the output; and
causing the action to be performed on the environment thereby causing the first state of the environment to change to a second state.

11. The system of claim 10, wherein the selecting the LAA from the plurality of LAAs comprises selecting the LAA based on an available action presented by the environment determined by the controller based on the observation of the first state.

12. The system of claim 10, wherein the selecting the LAA from the plurality of LAAs is performed by a neural network based model predicting which one of the plurality of LAAs is to be employed based on an input of the task instruction and the observation of the first state.

13. The system of claim 10, wherein the output from the selected LAA comprises a recommended action.

14. The system of claim 10, wherein the output from the selected LAA comprises information relating to the performance of one or more past actions performed on the environment.

15. The system of claim 10, wherein each LAA of the plurality of LAAs is implemented on a neural network based language model.

16. The system of claim 10, wherein the plurality of LAAs are hosted on one or more external servers.

17. The system of claim 10, wherein the plurality of LAAs are hosted on a same server as the controller.

18. The system of claim 10, the operations further comprising:
collecting a feedback from the environment after the action is performed on the environment;
determining, by the controller, that the feedback indicates the action was unsuccessful to achieve a desired goal corresponding to the task instruction; and
determining, by the controller together with one or more of the plurality of LAAs, a subsequent action in response to the determination.

19. A non-transitory machine-readable medium comprising a plurality of machine-executable instructions which, when executed by one or more processors, are adapted to cause the one or more processors to perform operations comprising:
receiving, via a data interface, a task instruction to be performed using an environment;
receiving, by a controller from the environment, an observation of a first state of the environment;
selecting, by the controller, a language model augmented agents (LAA) from a plurality of LAAs based on the task instruction and the observation;
obtaining an output from the selected LAA generated using an input combining the task instruction, the observation, and an LAA-specific prompt template;
determining, by the controller, an action based on the output; and
causing the action to be performed on the environment thereby causing the first state of the environment to change to a second state.

20. The non-transitory machine-readable medium of claim 19, wherein the selecting the LAA from the plurality of LAAs comprises selecting the LAA based on an available action presented by the environment determined by the controller based on the observation of the first state.
